(19) United States
(12) Patent Application Publication
(10) Pub. No.: US 2006/0093360 A1
(43) Pub. Date: May 4, 2006

(54) Loop-back wavelength division multiplexing passive optical network

(76) Inventors: Byoung Whi Kim, Daejeon (KR); Woo Ram Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/122,839

(22) Filed: May 4, 2005

(30) Foreign Application Priority Data
Oct. 28, 2004 (KR) 10-2004-0086570

(51) Int. Cl. H04J 14/00

(52) U.S. Cl. 398/71

(57) ABSTRACT

Disclosed herein is a loop-back Wavelength Division Multiplexing Passive Optical network (WDM-PON). The loop-back WDM-PON includes a coupler, a terminal receiver, and a reflective semiconductor amplifier. The coupler branches a downstream signal, which is transmitted from a central office, into first and second downstream signals. The terminal receiver receives and converts the first downstream signal into electrical signal and provides the electrical signal to a subscriber. The reflective semiconductor optical amplifier flattens modulated optical power of the second downstream signal input to the RSOA and re-modulating the flattened signal by changing driving current in response to upstream data.

### RELATED APPLICATIONS

The present application is based on, and claims priority from, Korean Application Number 2004-0086570, filed Oct. 28, 2004, the disclosure of which is incorporated by reference herein in its entirety.

### BACKGROUND OF THE INVENTION

1. Field of the Invention

The present invention relates generally to a wavelength division multiplexing passive optical network and, more particularly, to a loop-back passive optical network.

2. Description of the Related Art

Currently, a Digital Subscriber Line (DSL) technology using an Unshielded Twisted Pair (UTP) and a Cable Modem Termination System (CMTS) technology using a Hybrid Fiber Coaxial (HFC) network have been widely used as information transmission technologies for communication systems. It is expected that it is difficult for such DSL and CMTS technologies to provide a bandwidth and a quality guarantee sufficient to provide voice, data and broadcast convergence service, which will be popularized within a few years, to subscribers. In order to solve the problem, a Fiber To The Home (FTTH) technology that connects optical fiber all the way to subscribers' homes is being researched throughout the world. The most important key to the development of the FTTH technology is the development of an optical signal transmission method that is superior in economical efficiency and mass productivity in the point of view of the characteristics of a subscriber line.

FTTH networks may be classified into a Passive Optical Network (PON) and an Active Optical Network (AON). The PON is being currently developed in the forms of an Asymmetric Transfer Mode (ATM)-PON, a B-PON, a G-PON and an E-PON. The AON is being developed into a form that connects local networks, which are each composed of Ethernet switches, using optical fiber. In the two above-described types of FTTH networks, a data transmission optical transmission path is constructed on a single wavelength per transmission direction basis, which has a limitation in providing a quality-guaranteed wide bandwidth of more than 100 Mb/s to subscribers. In order to overcome such a limitation, attempts to introduce a Wavelength Division Multiplexing (WDM) technology to a FTTH subscriber network are being eagerly made.

A WDM-based FTTH network, that is, a WDM-PON, is a scheme in which the communication between a central base station and subscribers is performed using a wavelength assigned to each subscriber. Such a WDM-PON is advantageous in that the WDM-PON can provide independent and high-capacity communication channel with excellent security to each subscriber. Furthermore, in the WDM-PON, the modulation and demodulation of light are performed for each subscriber unlike a Time Division Multiplexing (TDM) type, so that a light source having low modulation speed and a receiver having narrow bandwidth can be employed as compared with those of TDM type. However, the WDM-PON requires light sources having multiple wavelengths the number of which is identical of that of subscribers, so that an economical burden is imposed on a telecommunications service provider and, therefore, there is difficulty in deployment. Accordingly, it is important to develop a low cost WDM-PON light source. Considering the maintenance of the network, the fact that the service provider must prepare different light sources having different wavelengths for individual subscribers may impose a burden on the service provider. Therefore, light sources for subscribers are required to be of indistinction in wavelength, that is, wavelength-independent light sources to all the subscribers is required for a practical deployment of the WDM-PON.

A recently researched light source for the WDM-PON includes a spectrum-sliced light source that produces rays of light having a plurality of regular wavelength intervals at one time by spectrum-slicing a Broadband Light Source (BLS), such as an Amplified Spontaneous Emission (ASE) source or Light Emitting Diode (LED), using a wavelength division element, such as an Arrayed Waveguide Grating (AWG). The spectrum-sliced light source can wavelength-independently provide the same light to each subscriber. However, the spectrum-sliced light source is disadvantageous in that the output power and modulation speed thereof are low. Accordingly, in order to solve the disadvantages of the spectrum-sliced light source, an ASE injected Fabry-Perot Laser Diode (FP-LD), which is formed by injecting a spectrum-sliced ASE into a FP-LD and is used like a single mode light source, has been developed. The ASE injected FP-LD can wavelength-independently provide not only the same light to each subscriber but also high output power and high modulation speed. However, the ASE injected FP-LD is expensive and separate temperature control is required for the FP-LD of an optical network terminal.

In order to overcome the above-described disadvantages of the general WDM-PON in which an optical network terminal is equipped with a light source, a loop-back optical network can be taken into consideration. In this case, the look-back optical network refers to the scheme in which a central office transmits light to be used at an optical network terminal along with a downstream signal, and the optical network terminal re-modulates the light, which is transmitted from the central office, to an upstream signal and retransmits the upstream signal to the central office, unlike the above-described WDM-PON.

U.S. Pat. No. 5,559,624 entitled “Communication terminal based on remote interrogation of terminal equipment” discloses a look-back WDM-PON. In the loop-back optical network such as the preceding patent, a Mach-Zehnder modulator or an Electro-Absorption (EA) modulator has been used at an optical network terminal. However, since the Mach-Zehnder modulator or an EA modulator is expensive, it is difficult for subscribers to use it. Furthermore, the Mach-Zehnder modulator or an EA modulator has high insertion loss. Accordingly, a problem arises in that reception power is considerably reduced when a downstream signal, the optical power of which is reduced while the downstream signal is transmitted from a central office through a transmission path such as an optical fiber, is returned from the optical network terminal to the central office using the Mach-Zehnder modulator or an EA modulator having high insertion loss. Such power loss affects the transmission rate of upstream data, and may cause proper reception of the upstream data to be impossible in some cases.

### SUMMARY OF THE INVENTION

Accordingly, the present invention has been made keeping in mind the above problems occurring in the prior art, and an object of the present invention is to provide a loop-back WDM-PON, which is capable of eliminating power loss that occurs while downstream light transmitted from a central office is re-modulated to an upstream signal at optical network terminals and is retransmitted to the central office, and has a simple structure compared to the prior art.

In order to accomplish the above object, the present invention provides a loop-back WDM-PON, comprising a coupler for branching a downstream signal, which is transmitted from a central office, into first and second downstream signals; a terminal receiver for receiving and converting the first downstream signal into electrical signal and providing the electrical signal to a subscriber; and a Reflective Semiconductor Optical Amplifier (RSOA) for flattening a modulated optical power of the second downstream signal input to the RSOA and re-modulating the flattened signal by changing driving current in response to upstream data.

In the loop-back WDM-PON according to a first embodiment of the present invention, the coupler is positioned between a remote node and the terminal receiver and branches the downstream signal demultiplexed and assigned to the subscriber.

The loop-back WDM-PON according to the first embodiment of the present invention further includes a circulator that is positioned between the coupler and the RSOA and maintains a direction of an upstream signal transmitted from the RSOA.

In the loop-back WDM-PON according to a second embodiment of the present invention, the coupler is positioned between the central office and a remote node optical multiplexer and branches a multiplexed downstream signal.

The loop-back WDM-PON according to the second embodiment of the present invention further includes a circulator that is positioned between the coupler and the remote node multiplexer, transfers the second downstream signal to the RSOA, and transfers the upstream signal, which is transmitted from the RSOA, to the central office.

In the loop-back WDM-PON according to a third embodiment of the present invention, the coupler is positioned between the central office and a remote node optical multiplexer/demultiplexer and branches a multiplexed downstream signal.

The loop-back WDM-PON according to the third embodiment of the present invention further includes a circulator that is positioned between a central office optical multiplexer and the coupler and adjusts a direction of the multiplexed downstream signal or a multiplexed upstream signal.

Preferably, the RSOA has a saturated gain at power that is lower than power of the downstream signal at the input port of the RSOA.

Preferably, the RSOA is packaged in a To-Can form.

Preferably, the RSOA has a similar gain when polarization of the downstream signal is changed.

Preferably, the RSOA has a “0” level gain higher than a “1” level gain in a saturated state.

Preferably, the central office comprises a central office receiver that receives the upstream signal using a PIN-photodiode or avalanche photodiode.

Preferably, the downstream signal is generated and transmitted by a single mode light source at the central office.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a loop-back WDM-PON according to a first embodiment of the present invention;

FIG. 2a is a diagram illustrating the structure of a general semiconductor optical amplifier;

FIG. 2b is a diagram illustrating the structure of an RSOA that is applied to the optical network terminal of a loop-back WDM-PON according to the present invention;

FIG. 3 is a graph showing the principle of re-modulating a downstream signal to an upstream signal in an RSOA in accordance with an embodiment of the present invention;

FIG. 4 is a diagram illustrating the configuration of a loop-back WDM-PON according to a second embodiment of the present invention; and

FIG. 5 is a diagram illustrating the configuration of a loop-back WDM-PON according to a third embodiment of the present invention.

### DESCRIPTION OF THE PREFERRED EMBODIMENTS

Reference now should be made to the drawings, in which the same reference numerals are used throughout the different drawings to designate the same or similar components.

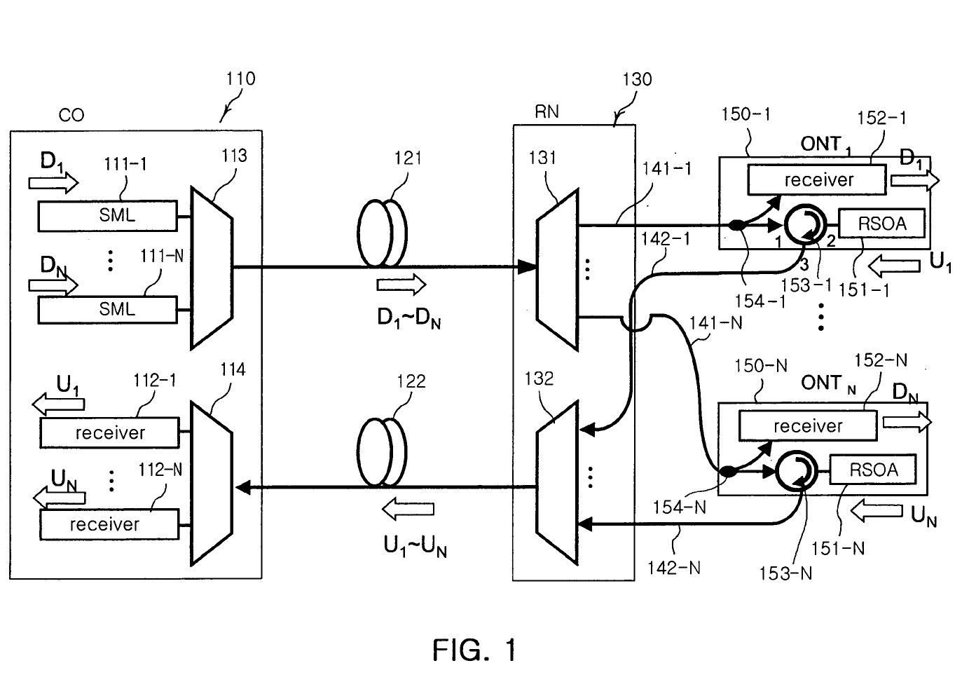

FIG. 1 is a diagram illustrating the configuration of a loop-back WDM-PON according to a first embodiment of the present invention.

Referring to FIG. 1, an RSOA-based loop-back WDM-PON system according to the first embodiment of the present invention includes a central office (CO) 110, upstream and downstream optical fibers 121 and 122, a remote node (RN) 130, downstream signal optical fibers 141-1 to 141-N, upstream signal optical fibers 142-1 to 142-N, and optical network terminals (ONTs) 150-1 to 150-N.

The central office 110 includes light sources 111-1 to 111-N, central office receivers 112-1 to 112-N, a central office optical multiplexer 113, and a central office optical demultiplexer 114. For example, Single Mode Laser diodes (SMLDs), such as Distributed Feedback Laser Diodes (DFB-LDs), may be used as the light sources 111-1 to 111-N, and are constructed separately or in an integrated array form. The lights of single mode laser diodes, having N wavelengths that are assigned to the N optical network terminals 150-1 to 150-N, respectively, are modulated by downstream electrical signals Di (i=1˜N). The central office receivers 112-1 to 112-N may be also constructed using PIN Photodiodes (PIN-PDs) or Avalanche Photodiodes (APDs), and receive upstream signals from the optical network terminals 150-1 to 150-N. The central office multiplexer 113 multiplexes the outputs of the N single mode light sources 111-1 to 111-N and transfers a multiplexed downstream signal to the downstream optical fiber 121.

The remote node 130 includes a remote node optical demultiplexer 131 and a remote node optical multiplexer 132. The optical demultiplexer 131 demultiplexes the multiplexed downstream signal and then distributes demultiplexed downstream signals to the individual optical network terminals 150-1 to 150-N through the downstream signal optical fibers 141-1 to 141-N according to wavelength.

The optical network terminals 150-1 to 150-N include RSOAs 151-1 to 151-N, terminal optical receivers 152-1 to 152-N, circulators 153-1 to 153-N and couplers 154-1 to 154-N.

The couplers 154-1 to 154-N divide downstream signals transferred through the downstream signal optical fibers 141-1 to 141-N and distribute divided optical signals to the RSOAs 151-1 to 151-N and the optical receivers 152-1 to 152-N in consideration of the receiving sensitivity of the terminal receivers 152-1 to 152-N and the power budget of the upstream signals. That is, the couplers 154-1 to 154-N function to branch the downstream signals into first optical signals, which will be transferred to the RSOAs 151-1 to 151-N, and second optical signals, which will be transferred to the optical receivers 152-1 to 152-N.

The circulators 153-1 to 153-N are positioned between the couplers 154-1 to 154-N and the RSOAs 151-1 to 151-N, and function to transfer upstream signals Ui (i=1˜N) to the remote node optical multiplexer 132 by adjusting the directions of the upstream signals that are transmitted from the RSOAs 151-1 to 151-N.

The terminal optical receivers 152-1 to 152-N receive and reconstruct the downstream signals Di and provide the downstream signals Di to subscribers.

The RSOAs 151-1 to 151-N amplitude squeeze input downstream signals Di in a gain saturation region for flattening the optical power of the input downstream signals Di, re-modulate the squeezed optical signals (flattened signals) by changing driving current in response to upstream signals Ui, and transmit the upstream signals Ui to the central office 110.

The light modulated to the upstream signals is passed through the circulators 153-1 to 153-N and the upstream signal optical fibers 142-1 to 142-N, multiplexed through the optical multiplexer 132 of the remote node 130, and input to the central office 110 through the upstream optical fiber 122. The multiplexed light input to the central office 110 is demultiplexed according to channel, and input to the central office optical receivers 112-1 to 112-N. The central office optical receivers 112-1 to 112-N finally receive the upstream signals U_{N}.

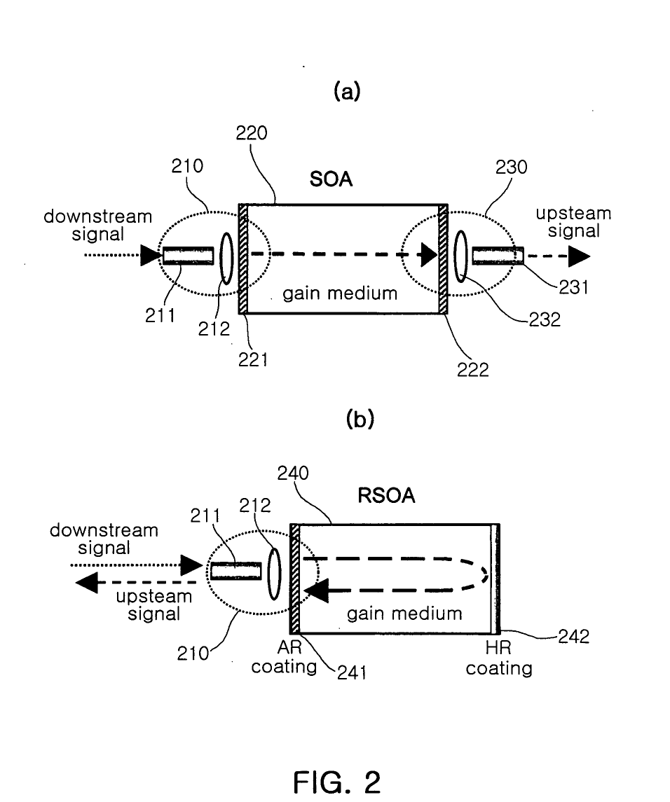

FIG. 2a illustrates the structure of a general Semiconductor Optical Amplifier (SOA), and FIG. 2b illustrates the structure of an RSOA that is applied to the optical network terminal of the loop-back WDM-PON according to the present invention.

Referring to FIG. 2a, a typical SOA is constructed such that Anti-Reflection (AR) coatings are formed on the side surfaces of a SOA chip 220. Accordingly, when a downstream signal is input to one side surface 221 through an input optical fiber 211, the downstream signal is amplified while passing through a gain medium, and an upstream signal is output to an output optical fiber 231 through an opposite surface.

Referring to FIG. 2b, the RSOA that is applied to the optical network terminal of the loop-back WDM-PON according to the present invention is constructed such that an AR coating is formed on one side surface of an RSOA chip 240 and a High-Refection (HR) coating is formed on the opposite side surface of the RSOA chip 240. Input to and output from the RSOA are performed though a single optical fiber 211.

In general, SOA is packaged in a butterfly type package because in the package there exist two pigtails 210 and 230, and lenses 212 and 232 to connect the SOA chip 220.

In contrast, with the RSOA, there exists only a single pigtail 210 and a lens 212 in the package. Accordingly, unlike the general SOA, the RSOA can be packaged not only into the butterfly type package but also into a To-Can type package in the case where the length of the chip 240 is appropriately adjusted. The To-Can type package has the advantages of low cost and miniaturization compared to the butterfly type package. Furthermore, since the AR coating that is difficult to make is formed only on one side surface of the chip 240, the RSOA can be more easily fabricated. The gain bandwidth of the RSOA is more than 30 nm and the gain magnitude is more than 10 dB, so that the RSOA can accommodate many WDM channels and compensate for loss that is experienced during travel along a downstream path.

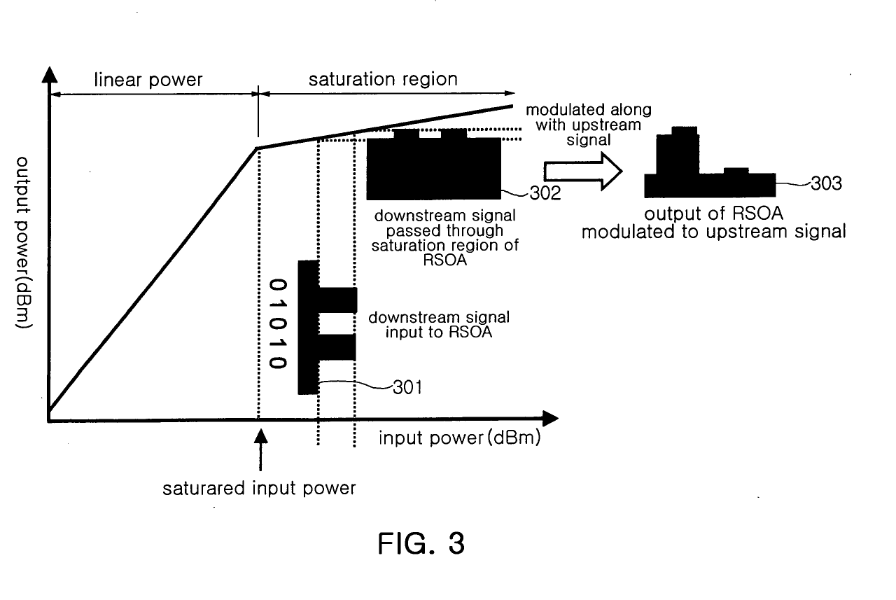

FIG. 3 is a graph showing the principle of re-modulating a downstream signal to an upstream signal in an RSOA in accordance with an embodiment of the present invention.

Referring to FIG. 3, when the RSOA is operated in a gain saturation region, a gain obtained at a “0” level is larger than that obtained at a “1” level, so that a downstream signal 301 is converted into a signal 302 in which the difference in power at “0” and “1” levels is reduced after being input to the RSOA. In this state, when operating current introduced to a RSOA (151-1 to 151-N) according to an upstream signal varies, that is, if direct modulation is performed, an RSOA optical output 303 is modulated according to upstream data. In general SOA design, an attempt to widen a linear region by increasing available saturation input power is made. In contrast, in the present invention, a terminal RSOA is employed for the purpose of re-modulation, and the saturation input power of the terminal RSOA is preferably lower than that of a downstream signal at the “0” level at the input port of the RSOA. Furthermore, it is preferred that the RSOAs 151-1 to 151-N have the same or a similar optical gain and, therefore, are optical polarization-independent.

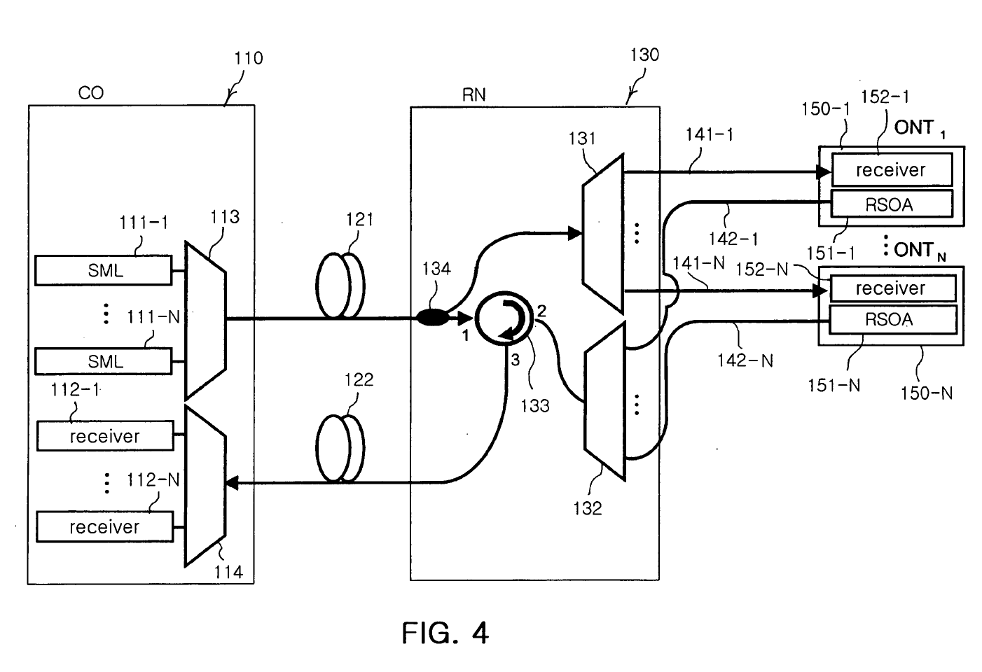

FIG. 4 is a diagram illustrating the configuration of a loop-back WDM-PON according to a second embodiment of the present invention.

The loop-back WDM-PON according to the first embodiment of the present invention, which is shown in FIG. 1, has a structure in which the optical network terminals 150-1 to 150-N are provided with the couplers 154-1 to 154-N and the circulators 153-1 to 153-N, respectively, so that it is relatively expensive and has a somewhat complicated structure. In contrast, in the loop-back WDM-PON according to the second embodiment of the present invention, a coupler 134 and a circulator 133 are positioned in a remote node 130 and shared by subscribers, thus resulting in a structure that reduces the cost and complexity of constructing a network.

Referring to FIG. 4, in the loop-back WDM-PON according to the second embodiment of the present invention, a multiplexed downstream signal is input from a central office 110 to the remote node 130 through a downstream optical fiber 121. The coupler 134 positioned inside the remote node 130 divides the downstream signal and distributes the divided downstream signals to terminal receivers 152-1 to 152-N and RSOAs 151-1 to 151-N positioned in optical network terminals 150-1 to 150-N. Thereafter, a downstream signal (first downstream signal) to be transferred to the terminal receivers 152-1 to 152-N branches off and is input to the terminal receivers 150-1 to 150-N through an optical demultiplexer and downstream signal optical fibers 141-1 to 141-N.

Downstream signals (second downstream signal) to be input to the RSOAs 151-1 to 151-N are divided according to wavelength by a remote node optical multiplexer/demultiplexer 132 and are input to the optical network terminals 150-1 to 150-N. The light re-modulated to upstream signals and output from the RSOAs 151-1 to 151-N is transmitted to the remote node optical multiplexer/demultiplexer 132 through upstream signal optical fibers 142-1 to 142-N, multiplexed by the remote node optical multiplexer/demultiplexer 132, and input to the central office 110 through the circulator 133 and an upstream optical fiber 122. The circulator 133 functions to adjust the direction of an optical signal so that the branched-off second downstream signal can be transferred to the RSOAs 151-1 to 151-N through the remote node optical multiplexer/demultiplexer 132, and the upstream signal output from the remote node optical multiplexer/demultiplexer 132 is transferred to the central office 110 through the upstream optical fiber 122.

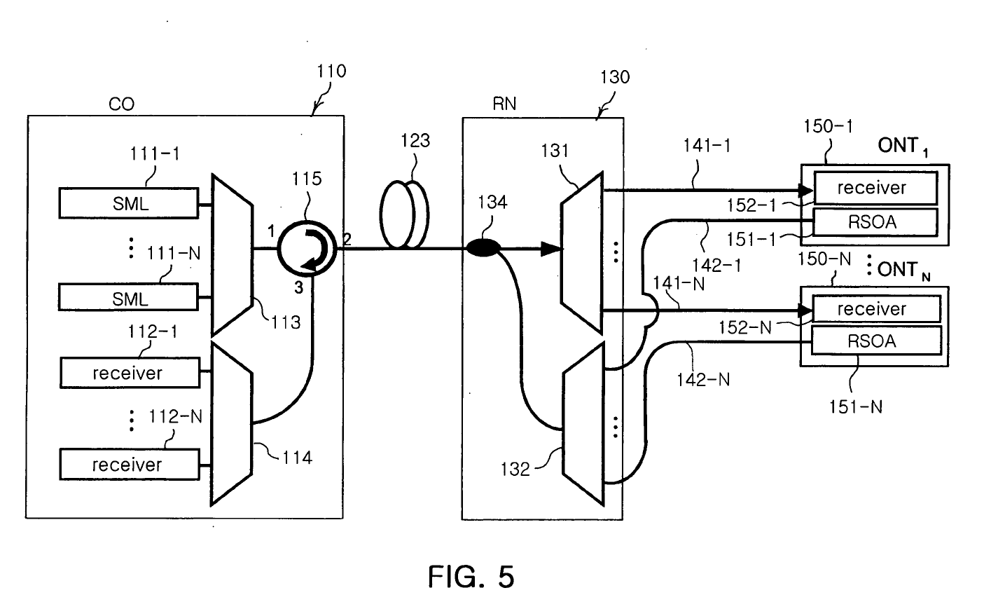

FIG. 5 is a diagram illustrating the configuration of a loop-back WDM-PON according to a third embodiment of the present invention.

The loop-back WDM-PON according to the second embodiment of the present invention, which is shown in FIG. 4, has a structure in which the upstream optical fiber 121 and the downstream optical fiber 122 are separately used, whereas the loop-back WDM-PON according to the third embodiment of the present invention is constructed to transmit both an upstream signal and a downstream signal through a single optical fiber.

Referring to FIG. 5, in the loop-back WDM-PON according to the third embodiment of the present invention, a circulator 115 is positioned in a central office 115, and a coupler 134 is positioned in a remote node 130. The outputs of single mode light sources 111-1 to 111-N modulated to a downstream signal in the central office 110 are multiplexed by an optical multiplexer 113, and input to the remote node 130 through the circulator 115 and an upstream/downstream optical fiber 123. The downstream signal input to the remote node 130 is distributed by the coupler 134 of the remote node 130 so that the downstream signal is divided between the terminal receivers 152-1 to 152-N and RSOAs 151-1 to 151-N of optical network terminals 150-1 to 150-N. A downstream signal (first downstream signal) to be transferred to the terminal receivers 152-1 to 152-N is input to the terminal receivers 150-1 to 150-N through the optical demultiplexer 131 of the remote node 130 and downstream signal optical fibers 141-1 to 141-N. A downstream signal (second downstream signal) to be input to the RSOAs 151-1 to 151-N and re-modulated to an upstream signal is divided according to wavelength by a remote node optical multiplexer/demultiplexer 132, and input to the RSOAa 151-1 to 151-N of the optical network terminals 150-1 to 150-N through optical fibers 142-1 to 142-N. Thereafter, light re-modulated to an upstream signal and output from the RSOAs 151-1 is transferred to the remote node optical multiplexer/demultiplexer 132 through the optical fibers 142-1 to 142-N, multiplexed by the remote node optical multiplexer/demultiplexer 132, and transmitted to the central office 110 through the coupler 134 and the upstream/downstream optical fiber 123. In this case, the upstream signal input to the central office 110 is input to a central office optical demultiplexer 114 through the circulator 115. The upstream signal is divided according to wavelength by the central office optical demultiplexer 114 and input to the central office receivers 112-1 to 112-N, thereby reconstructing the upstream signal.

In accordance with the present invention described above, in the loop-back WDM-PON, the central office uses single mode light sources to transmit downstream data, and the optical network terminals re-modulate a part of the downstream data to upstream data and transmit the upstream data. Accordingly, additional light sources are not required to transmit the upstream data, and excellent transmission performance can be obtained because bit noise does not occur in a channel. Furthermore, since the line width of a light source is narrow, the influence of chromatic dispersion is low though a transmission distance is long.

Furthermore, in accordance with the present invention, the RSOA is used as an amplifier, so that 1.25 Gbps data can be directly modulated without being influenced by a ambient temperature. Accordingly, compared to a conventional loop-back network using a Mach-Zehnder modulator or an EA modulator, network construction costs can be considerably reduced, optical power loss can be compensated for at the optical network terminals, and there is no influence of optical polarization.

Furthermore, the present invention is advantageous in that the production, installation and maintenance costs of the optical network terminals can be saved because the same RSOAs are used regardless of wavelength and the network can be easily extended because the power of light, which is looped back and transmitted upstream, is not attenuated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A loop-back Wavelength Division Multiplexing-Passive Optical Network (WDM-PON), comprising:
a coupler for branching a downstream signal, which is transmitted from a central office, into first and second downstream signals;
a terminal receiver for receiving and converting the first downstream signal into electrical signal and providing the electrical signal to a subscriber; and
a Reflective Semiconductor Optical Amplifier (RSOA) for flattening a modulated optical power of the second downstream signal input to the RSOA and re-modulating the flattened signal by changing driving current in response to upstream data.

2. The loop-back WDM-PON as set forth in claim 1, wherein the coupler is positioned between a remote node and the terminal receiver and branches the downstream signal demultiplexed and assigned to the subscriber.

3. The loop-back WDM-PON as set forth in claim 2, further comprising a circulator that is positioned between the coupler and the RSOA and adjusts a direction of an upstream signal transmitted from the RSOA.

4. The loop-back WDM-PON as set forth in claim 1, wherein the coupler is positioned between the central office and a remote node optical multiplexer and branches a multiplexed downstream signal.

5. The loop-back WDM-PON as set forth in claim 4, further comprising a circulator that is positioned between the coupler and the remote node multiplexer, transfers the second downstream signal to the RSOA, and transfers the upstream signal, which is transmitted from the RSOA, to the central office.

6. The loop-back WDM-PON as set forth in claim 1, wherein the coupler is positioned between the central office and a remote node optical multiplexer/demultiplexer and branches a multiplexed downstream signal.

7. The loop-back WDM-PON as set forth in claim 6, further comprising a circulator that is positioned between a central office optical multiplexer and the coupler and adjusts a direction of the multiplexed downstream signal or a multiplexed upstream signal.

8. The loop-back WDM-PON as set forth in claim 1, wherein the RSOA has a saturated gain at power that is lower than power of the downstream signal at the input port of the RSOA.

9. The loop-back WDM-PON as set forth in claim 1, wherein the RSOA is packaged in To-Can form.

10. The loop-back WDM-PON as set forth in claim 1, wherein the RSOA has a similar gain when polarization of the downstream signal is changed.

11. The loop-back WDM-PON as set forth in claim 1, wherein the RSOA has a “0” level gain higher than a “1” level gain in a saturated state.

12. The loop-back WDM-PON as set forth in claim 1, wherein the central office comprises a central office receiver that receives the upstream signal using a PIN-Photodiode (PIN-PD) or Avalanche Photodiode (APD).

13. The loop-back WDM-PON as set forth in claim 1, wherein the downstream signal is generated and transmitted by a single mode light source at the central office.
